(19) United States
(12) Patent Application Publication
(10) Pub. No.: US 2020/0206885 A1
(43) Pub. Date: Jul. 2, 2020

(54) TRANSPORTATION AND ELEVATION ASSIST DEVICE AND METHOD FOR TOOL HAVING STUCK BIT

(71) Applicant: Donald Pyron, Camden, AR (US)

(72) Inventor: Donald Pyron, Camden, AR (US)

(21) Appl. No.: 16/731,915

(22) Filed: Dec. 31, 2019

Related U.S. Application Data
(60) Provisional application No. 62/787,065, filed on Dec. 31, 2018.

(51) Int. Cl. B25D 17/32; B25D 17/30; B62B 1/00; B62B 1/26; B62B 5/04

(52) U.S. Cl. CPC B25D 17/32; B25D 17/30; B25D 9/04; B62B 1/26; B62B 5/04; B62B 1/008

(57) ABSTRACT

A tool for removing a stuck bit of a drilling device from the drilling medium in which it was being drilled is provided. The system generally comprises a frame, a hydraulic lift operably connected to the frame, and a lifting platform. Operating the hydraulic lifting device may cause a strut to move in a linear direction, which may cause the carriage to move in a linear direction. By moving the strut in linear direction such that the carriage extends beyond the length of the drilling device, the carriage may contact the drilling medium, which may cause a lifting force to be applied to the drilling device. A user may then use the carriage to move the drilling device to a new location.

### CROSS REFERENCES TO RELATED APPLICATIONS

This application claims priority to U.S. Provisional Patent Application Ser. No. 62/787,065, filed Dec. 31, 2018, in which said application is incorporated herein in its entirety by reference.

### FIELD OF THE DISCLOSURE

The subject matter of the present disclosure refers generally to a tool for removing a stuck bit of a drilling or hammering device from the medium in which it was being drilled or hammered.

### BACKGROUND

Pneumatic hammers and/or hammer drills are an important tool used in construction all over the world. Pneumatic hammers are often used to break up hard materials such as concrete for demolition applications. These devices are also used when it is necessary to hammer/chip/drill through hard surfaces, created by materials such as asphalt. When drilling through these various services, pneumatic hammers may become lodged or otherwise stuck in the material, which leads to several problems. First, this can greatly affect the time it takes to perform a task because removing a bit lodged in the drilling medium takes time to dislodge. Second, lodged bits may potentially cause damage to the pneumatic hammers by, for instance, overheating the engine. Not only will a damaged pneumatic hammer increase the cost of a job due to repairs or replacement, but this will further increase the time to perform a job.

There are several methods used to release a lodged or otherwise stuck bit of a drilling device from a drilling medium. One method includes using compressed air to remove dust buildup around the bit so that the drilling device may be pulled out. Another method involves pumping fluid into the hole in which the bit is stuck in hopes that the fluid may remove some of the dust and lubricate the drill so that it may slide out. In situations where concrete is the drilling medium, a slightly acidic fluid may be pumped into the hole in which the bit is stuck in hopes that the acidic fluid may dissolve the concrete and allow for an easier removal of the bit. Yet another method of removal involves detaching the pneumatic hammer from the bit, attaching a hydraulic device to the bit, and forcibly removing the bit from the drilling medium. All of these methods significantly increase the time and cost to complete the job.

Accordingly, there is a need in the art for a tool that attaches to a pneumatic hammer and liberates lodged or otherwise stuck bits of a drilling device from a drilling medium in order to increase efficiency at a job site and decrease overall costs.

### DESCRIPTION

A tool for removing a lodged or otherwise stuck bit of a drilling or hammering device from the medium in which it was being drilled or hammered is provided. In one aspect, the present invention is a system and method for removing a stuck bit of a drilling device from a drilling medium. In another aspect, the present invention is a system and method for transporting a drilling device. Generally, the system and method of the present disclosure are designed to allow a user to both transport a large drilling device to a location in which a medium must be broken up or drilled and then liberate bits of the drilling device when they get stuck in the drilling medium.

The system generally comprises a drilling device, a hydraulic lift operably connected to the drilling device, and carriage operably connected to the hydraulic lift. The drilling device of the system may use a bit to drill holes into the medium. The bit may take a number of shapes and be manipulated by the drilling device in a way such that the bit may puncture the medium in which it is engaged. In one preferred embodiment, the drill bit may comprise two radial edges that extend about a central axis and end in a point. The drilling device for such a bit may rotate the bit around a central axis. The drill bit may also comprise a large chisel designed to fracture the medium or to punch a hole in the medium. The drilling device for such a bit may move the bit up and down in a lateral direction such that the bit may make quick successive impacts with the drilling medium. Alternatively, the bit of a drilling device may comprise two radial edges that extend about a central axis and end in a chisel. The drilling device for such a bit may both rotate the bit and move the bit up and down in a lateral direction in order to simultaneously drill and fracture a medium.

The hydraulic lifting device may comprise a hydraulic pump, hydraulic fluid, hydraulic reservoir, control valves, a user control, an actuator connected to the hydraulic pump via a plurality of tubes, and a plurality of seals. A switch may be connected to the control valves in a way such that it instructs the control valve which route through the plurality of tubes the hydraulic fluid may take to the actuator. The actuator may comprise a hydraulic cylinder defined by an internal cavity, a slidably moveable piston disposed within the internal cavity, and a strut operably connected to the slidably moveable piston. The hydraulic cylinder may be operably connected to the switch and control valves via the plurality of tubes in a way such that hydraulic fluid may be pumped into one of a first chamber or a second chamber of the hydraulic cylinder by the hydraulic pump. Pressure change resulting from hydraulic fluid being injected into the first chamber or second chamber acts on the slidably moveable piston, causing the slidably moveable piston to move in a direction from higher pressure to lower pressure. The strut is projected out the strut end of the hydraulic device and is moved in a lateral direction by the slidably moveable piston. An extension device may be attached to the end of the strut that may extend beyond the length of the drilling device when the strut is fully extended. The carriage may also be attached to the end of the strut. Operating the hydraulic lifting device to cause the strut to move in a linear direction may cause the carriage to move in a linear direction. By moving the strut in a linear direction such that the carriage extends beyond the length of the drilling device, the carriage may contact the drilling medium, which may cause a lifting force to be applied to the drilling device. A user may then use the carriage to move the drilling device to a new location. The lifting force exerted by the hydraulic lifting device to the drill via the carriage may also be used to free the bit of the drilling device when it gets stuck in the drilling medium.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a perspective view of a device in which techniques described herein may be implemented.

FIG. 2 is a perspective view of a device in which techniques described herein may be implemented.

FIG. 3 is a perspective view of a device in which techniques described herein may be implemented.

FIG. 4 is a flow chart illustrating certain method steps of a method embodying features consistent with the principles of the present disclosure.

FIG. 5 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As used herein, the term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “drilling medium” and grammatical equivalents thereof refers to the substance in which a drilling device is used to drill a hole or break apart. For example, a user may operate a jackhammer to break apart concrete, wherein the drilling medium is concrete. Materials that may act as the drilling medium may include, but are not limited to, concrete, brick, asphalt, fire brick, castable cement, or any combination thereof. As used herein, the term “generally” and grammatical equivalents thereof when used to describe an angle refers to the specified angle plus or minus fifteen degrees. For example, a jackhammer held at generally a ninety-degree angle could be held at an angle from seventy-five degrees to one-hundred-and-five degrees.

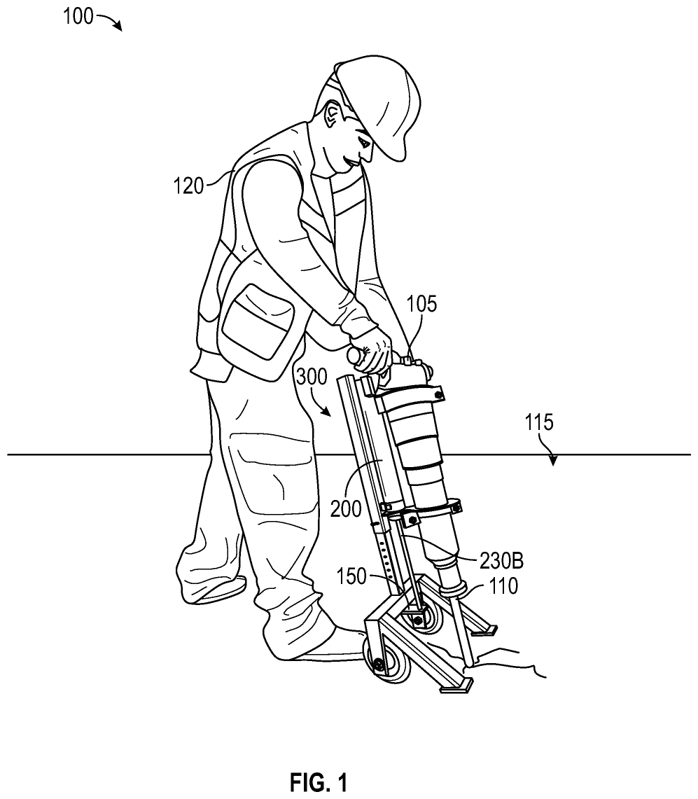

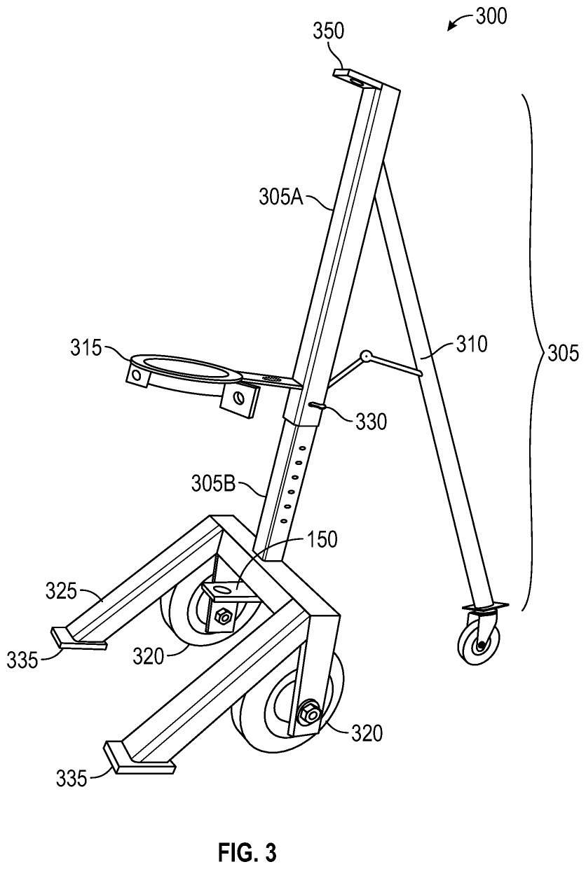

FIGS. 1-5 illustrate embodiments of a system 100 and its various methods for removing a stuck bit 110 of a drilling device 105 from the drilling medium 115 in which it was being drilled. As illustrated in FIG. 1 and FIG. 3, the system 100 generally comprises a carriage 300, a drilling device 105, and a hydraulic lifting device 200. In a preferred embodiment, as illustrated in FIG. 1, the hydraulic lifting device 200 is connected to the carriage 300 and is configured for attachment to a drilling device 105. In this embodiment, the drilling device 105 may be removeable from the carriage 300. This allows the carriage 300 to work separately from the drilling device 105 such that a user 120 may move the carriage 300 into position. The system 100 may be constructed such that the drilling device 105, hydraulic lifting device 200, and carriage 300 are one unit. Alternatively, the drilling device 105, hydraulic lifting device 200, and carriage 300 may be constructed separately and combined at a later time. For instance, a drilling device 105 and hydraulic lifting device 200 may be created as a single unit. In other embodiment, a drilling device 105 may have a hydraulic lifting device separate from the hydraulic lifting device 200 illustrated in FIG. 1. A carriage 300 may then be added to a tool such as a hammer or drill to create the system 100 disclosed herein.

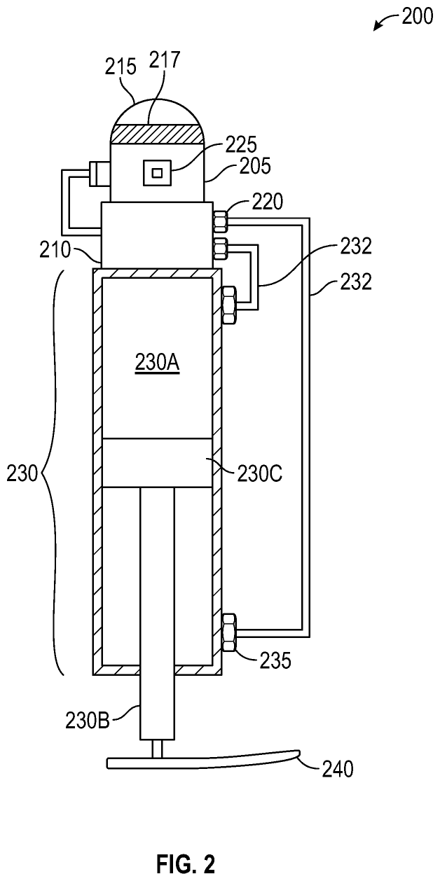

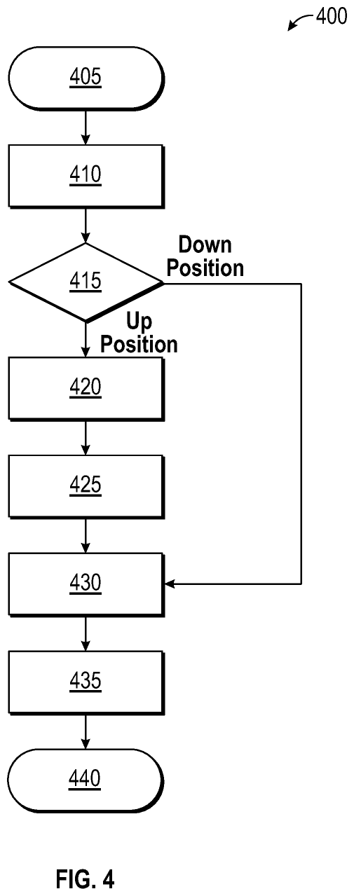

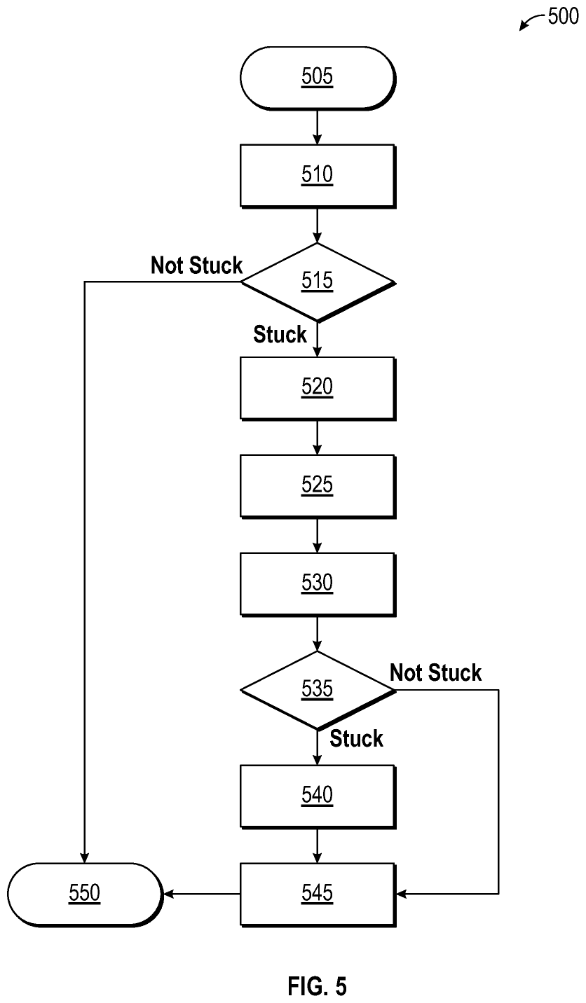

Although the system 100 and method of the present disclosure have been discussed for use within the construction field, one of skill in the art will appreciate that the inventive subject matter disclosed herein may be utilized in other fields or for other applications in which a hydraulic lifting device 200 may be used to remove a device stuck in a drilling medium 115. It is understood that the various method steps associated with the methods of the present disclosure may be carried out as operations by the system 100 shown in FIG. 1. FIG. 2 illustrates the various components of a hydraulic lifting device 200 that may be used to provide the lifting force necessary to free a stuck bit 110 from a drilling medium 115. FIG. 3 illustrates a transportation device that may be used to transport the drilling device 105 as well as provide a platform that presses against the drilling medium 115 such that it may free a stuck bit 110. The hydraulic lifting device 200 has been removed from FIG. 1. FIGS. 4 and 5 illustrate methods that may be carried out by a user 120 to transport a drilling device 105 and free a stuck bit 110 of a drilling device 105 from the drilling medium 115, respectively.

A drilling device 105 may be defined as an apparatus used to penetrate, breakup, chip, drill, or otherwise separate material of a drilling medium 115 into smaller pieces or holes. Devices that may act as the drilling device 105 may include, but are not limited to, pneumatic hammers, hydraulic hammers, and percussion drills. In a preferred embodiment, the drilling device 105 may use a bit 110 to drill or otherwise penetrate holes into the drilling medium 115. The bit 110 may take a number of shapes and be manipulated by the drilling device 105 in a way such that the bit 110 may puncture the drilling medium 115 in which it is engaged. In one preferred embodiment, the drill bit 110 may comprise two radial edges that extend about a central axis and end in a point. The drilling device 105 for such a bit 110 may rotate the bit 110 around a central axis. For instance, a hand drill having an auger bit 110 may be used to drill a hole in a piece of wood. Operation of the hand drill may cause the auger bit 110 to spin about a central axis, wherein simultaneously applying pressure to the piece of wood with the bit 110 while operating the hand drill may cause the auger bit 110 to drill the hole in the piece of wood. In one preferred embodiment, the drill bit 110 may comprise two radial edges that extend about a central axis and end in a point.

In another preferred embodiment, the drill bit 110 may comprise a large chisel. The drilling device 105 for such a bit 110 may move the bit 110 up and down in a lateral direction in order to fracture the drilling medium 115 or punch a whole into the drilling medium 115. For instance, a jackhammer having a hammer bit 110 may be used to punch a hole in a layer of concrete. Operation of the jackhammer may cause the hammer bit 110 to pound the concrete in quick successive bursts, causing the concrete to fracture. In yet another preferred embodiment, the bit 110 may comprise two radial edges that extend about a central axis and end in a chisel. The drilling device 105 for such a bit 110 may both rotate the bit 110 and move the bit 110 up and down in a lateral direction in order to both drill and fracture at the same time. For instance, a hammer drill may be used to drill a hole in a concrete block. The bit 110 is preferably configured such that it may be removed from the drilling device 105 by a user.

A hydraulic lifting device 200 may be defined as a tool that does work using fluid as the powering drilling medium 115. In one preferred embodiment, the drilling device 105 comprises a separate hydraulic lifting device to lift and lower the drill bit 110. In an embodiment, the hydraulic lifting device 200 is separate from the hydraulic lifting device of an attached hammer or drill and may comprise an engine 205, hydraulic pump 210, hydraulic reservoir 215, hydraulic fluid 217, control valves 220, a user control 225, an actuator 230 connected to the hydraulic pump 210 via a plurality of tubes 232, and a plurality of seals 235. The hydraulic pump 210 supplies the hydraulic fluid 217 to the various components of the hydraulic lifting device 200. The control valves 220 direct the hydraulic fluid 217 to various locations of the hydraulic lifting device 200 via the plurality of tubes 232. In a preferred embodiment, a switch is connected to the control valves 220 in a way such that it instructs the control valve 220 which route through the plurality of tubes 232 the hydraulic fluid 217 may take to the actuator 230. The actuator 230 is responsible for lifting the drilling device 105 using the work force generated by the pressure changes caused by the hydraulic fluid 217. The hydraulic reservoir 215 holds hydraulic fluid 217 not currently being used to operate the hydraulic lifting device 200. The plurality of seals 235 prevents the escape of hydraulic fluid 217 from the hydraulic lifting device 200. As illustrated in FIG. 1 and FIG. 3, in a preferred embodiment the hydraulic lifting device has a lower portion defined by a strut 230B which is connected to the frame lift attachment 150.

In the embodiment as illustrated in FIG. 2, the actuator 230 comprises a hydraulic cylinder defined by an internal cavity 230A, a slidably moveable piston 230C disposed within the internal cavity 230A, and a strut 230B operably connected to the slidably moveable piston 230C. The slidably moveable piston 230C may be shaped in a way such that it creates two chambers within the cavity. In a preferred embodiment, the hydraulic cylinder may be operably connected to the hydraulic pump 210 and control valves 220 via the plurality of tubes 232 in a way such that hydraulic fluid 217 may be pumped into one of a first chamber or a second chamber of the hydraulic cylinder by the hydraulic pump 210. Pressure change resulting from hydraulic fluid 217 being injected into the first chamber or second chamber acts on the slidably moveable piston 230C, causing the slidably moveable piston 230C to move in a direction from higher pressure to lower pressure. The strut 230B is projected out the strut end of the hydraulic lifting device 200. The strut 230B of the hydraulic lifting device 200 preferably extends beyond the length of the drilling device 105. In another preferred embodiment, an extension device 240 may be attached to the end of the strut 230B that may extend beyond the length of the drilling device 105 when the strut 230B is fully extended.

In one preferred embodiment, the extension device 240 attached to the end of the strut 230B may be a lifting platform 335. A lifting platform 335 may be a sturdy device having large amount of surface area relative to the end of the strut 230B. Operating the hydraulic lifting device 200 to cause the slidably moveable piston 230C to move in a direction from higher pressure to lower pressure and may cause the strut 230B to move in a linear direction, which in turn may cause the lifting platform 335 to move in a linear direction. By moving the strut 230B in linear direction such that the lifting platform 335 extends beyond the length of the drilling device 105, the lifting platform 335 may contact the drilling medium 115 and may cause a lifting force to be applied to the drilling device 105. If the bit 110 of the drilling device 105 is stuck within the drilling medium 115, the lifting force exerted by the hydraulic lifting device 200 may free the bit 110 from the drilling medium 115.

In another preferred embodiment, as illustrated in FIG. 1, the carriage 300 may be attached to the end of the strut 230B. Operating the hydraulic lifting device 200 to cause the slidably moveable piston 230C to move in a direction from higher pressure to lower pressure may cause the strut 230B to move in a linear direction, which in turn may cause the carriage 300 to move in a linear direction. By moving the strut 230B in linear direction such that the carriage 300 extends beyond the length of the drilling device 105, the carriage 300 may contact the drilling medium 115, which may cause a lifting force to be applied to the drilling device 105. A user 120 may then use the carriage 300 to move the drilling device 105 to a new location. The lifting force exerted by the hydraulic lifting device 200 may also be used to free the bit 110 of the drilling device 105 from the drilling medium 115. For instance, a carriage 300 comprising at least one wheel 320 and at least one base leg 325 may transfer the lifting force from the hydraulic lifting device 200 to the drilling medium 115, thus forcing the bit 110 free of the drilling medium 115.

A carriage 300 may be defined as a tool comprising a frame 305, at least one wheel 320 operably connected to the frame 305, and a tool connection element 315. The carriage 300 may be used by a user 120 to transport the drilling device 105 and hydraulic lifting device 200 to a desired location before using the drilling device 105 to do work. Once the user 120 has reached the desired location, the carriage 300 may be manipulated in a way such that it does not interfere with the drilling device 105 as it performs work. In one preferred embodiment, the carriage 300 may comprise a handle proximal to the upper portion of the drilling device 105, wherein a user 120 may use the handle to control the carriage 300. The carriage 300 may be tilted back by a user 120 until the weight of the drilling device 105 and hydraulic lifting device 200 are balanced over the at least one wheel 320, thus allowing for easier transportation of the drilling device 105. In the preferred embodiment as illustrated in FIG. 1, an at least one wheel 320 may be attached to the frame 305 such that it is positioned on either side of the drilling device 105 and hydraulic lifting device 200. The drilling device 105 may be attached to the transportation device 300 via the tool connection element 315. Devices that may act as the tool connection element 315 include, but are not limited to, vice grips, straps, and mounts, or any combination thereof. The device may further comprise an additional wheel 310 for transporting the frame 305 and drilling device 105. As illustrated in FIG. 1, the additional wheel 310 may be collapsible.

FIG. 3 illustrates one embodiment of the frame 305 with no hydraulic lifting device 200 attached. A preferred embodiment, as illustrated in FIG. 1, further comprises a hydraulic lifting device 200 connected thereto. As shown, the frame 305 may be adjustable and may comprise a top portion 305A and a bottom portion 305B. The top portion 305A may comprise a hydraulic lifting device attachment element 350 for attaching an upper portion of the hydraulic lifting device 200 to the frame 305. The bottom portion 305B may comprise a frame lift attachment 150 configured for securing a lower portion of the hydraulic lifting device 200 to the frame 305. In a preferred embodiment, the strut 230B of the hydraulic lifting device 200 may be extended through and secured to an aperture of the frame lift attachment 150 in a way such that the strut 230B is secured to the frame 305. The frame 305 may be configured to extend in a linear direction such that the length of the frame 305 may be increased or decreased, thus increasing or decreasing the length of the carriage 300 and the location of the at least one wheel 320 relative the drilling device 105. In a preferred embodiment, as illustrated in FIG. 1, movement of the strut along this linear direction may increase and decrease the length of the frame 305 by changing the relative position of the top portion 305A and bottom portion 305B to one another. In another preferred embodiment, the top portion 305A and bottom portion 305B are slideably secured to one another. For instance, the top portion 305A and bottom portion 305B may be telescopically secured to one another.

In a preferred embodiment, the frame 305 is partially or fully extendable. In another preferred embodiment, users 120 may manually extend or shorten the length of the frame 305 via physical interaction with the frame 305. A user 120 may lock the frame 305 in place manually or automatically via a frame locking mechanism 330 as shown in FIG. 3. Devices that may act as the frame locking mechanism 330 include, but are not limited to, push-pull pins, clamps, set knobs, snap locks, spring buttons, and clutch locks, or any combination thereof. By locking the frame 305 in place via a manual frame locking mechanism 330, a user 120 may lock the at least one wheel 320 in a position relative to the drilling device 105 based on the amount of frame 305 the user 120 has extended or shortened. In another embodiment, the frame 305 may be indirectly extended by the user 120 via operation of the hydraulic lifting device 200 (illustrated in FIG. 1). The hydraulic lifting device 200 may also be used to lock the adjustable arm of the carriage 300 in place, thus increasing or decreasing the length of the carriage 300 and locking the at least one wheel 320 in a position relative to the drilling device 105 based on the amount the strut 230B of the hydraulic lifting device 200 is extended. Alternatively, the frame 305 may be locked by both the frame locking mechanism 330 and the hydraulic lifting device 200.

Further illustrated in FIGS. 1 and 3, the carriage 300 further comprises at least one base leg 325. The at least one base leg 325 is a tubular entity having a frame end and a platform end, wherein the frame end is attached to the frame 305 and the platform end is attached to a lifting platform 335 that may support the carriage 300 in conjunction with the at least one wheel 320. The at least one base leg 325 may attach to the bottom portion 305B of the frame 305 and may be situated such that the frame may be supported by the at least one base leg 325 and at least one wheel 320 at a generally ninety-degree angle with the drilling medium 115. The at least one base leg 325 may not be attached to the base end of the bottom portion 305B of the frame. Instead, the at least one base leg 325 may be attached at a position between the top end and base end of the bottom portion 305B of the frame 305, wherein the at least one base leg 325 extends at an angle from the frame 305 and in a direction away from the at least one wheel 320. In some embodiments, this angle may be approximately forty-five degrees. The platform end of the at least one base leg 325 is angled such that the lifting platform 335 may sit generally flush against the drilling medium 115 when the frame 305 is at a generally ninety-degree angle with the drilling medium 115. In a preferred embodiment, the at least one base leg 325 and at least one wheel 320 may also support the drilling device 105 and hydraulic lifting device 200 at a generally ninety-degree angle.

FIG. 4 provides a flow chart 400 illustrating certain, preferred method steps that may be used to carry out the method of using the carriage 300 to transport the drilling device 105 and hydraulic lifting device 200. Step 405 indicates the beginning of the method. During step 410 the user 120 may determine whether the carriage 300 is in an up position or a down position. The user 120 may perform an action based on the position of the carriage 300 during step 415. If the carriage 300 is in the down position, the user 120 may proceed to step 430. If the carriage 300 is in the up position, the user 120 may activate the hydraulic lift during step 420 in a way such that it extends the carriage 300 in a down position. Once the hydraulic lifting device 200 has been engaged, the user 120 may wait for the carriage 300 to move into the down position during step 425. During step 430, the user 120 may tilt the drilling device 105 and hydraulic lifting device 200 using the carriage 300 in a way such that the weight of the drilling device 105 and hydraulic lifting device 200 is balanced on the at least one wheel 320 of the carriage 300. The user 120 may then transport the drilling device 105 using the carriage 300 during step 435, wherein the user 120 keeps the drilling device 105 and hydraulic lifting device 200 balanced over the at least one wheel 320 of the carriage 300 during the transportation process. Once the user 120 has transported the drilling device 105 to a new location, the method may proceed to the terminate method step 440.

FIG. 5 provides a flow chart 500 illustrating certain, preferred method steps that may be used to carry out the method of using the carriage 300 to remove a stuck bit 110 from its drilling medium 115. Step 505 indicates the beginning of the method. During step 510 the user 120 must determine whether the bit 110 of the drilling device 105 is stuck in the drilling medium 115. The user 120 may determine which action to take during step 515 based on the determination made during step 510. If the user 120 determines that the drill is not stuck within the drilling medium 115, the method may proceed to the terminate method step 550. If the user 120 determines that the bit 110 is stuck within the drilling medium 115, the user 120 may activate the hydraulic lift such that it extends the carriage 300 during step 520. Once the hydraulic lifting device 200 has been engaged, the user 120 may wait for the carriage 300 to engage the drilling medium 115 during step 525. Once the carriage 300 has engaged the drilling medium 115, the user 120 may once again determine whether the bit 110 is stuck within the drilling medium 115 during step 530. The user 120 may determine which action to take during step 535 based on the determination made during step 530. If the bit 110 is no longer stuck within the drilling medium 115, the user 120 may disengage the hydraulic lift during step 545. The method may then proceed to the terminate method step 550. If the user 120 determines that the bit 110 of the drilling device 105 is still stuck within the drilling medium 115, the user 120 may manipulate the carriage 300 in a way such that it may cause the bit 110 of the drilling device 105 to be loosened from the drilling medium 115 during step 540. Once the bit 110 has been liberated from the drilling medium 115 by the user 120, the user 120 may disengage the hydraulic lift during step 545. The method may then proceed to the terminate method step 550.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter.

What is claimed is:

1) A transportation and elevation assist device comprising:
a carriage comprising,
a frame having a top portion and a bottom portion,
at least one wheel connected to said bottom portion,
at least one lifting platform connected to said bottom portion, and
a hydraulic lift attached to said frame,
wherein said hydraulic lift moves said top portion and said bottom portion about one another.

2) The device of claim 1, wherein said hydraulic lift comprises an upper section and a lower section, wherein said upper section of said hydraulic lift is attached to said top portion of said frame, wherein said lower section of said hydraulic lift is attached to said bottom portion of said frame.

3) The device of claim 2, wherein said upper section of said hydraulic lift comprises a housing and said lower section of said hydraulic lift comprises a strut.

4) The device of claim 3, wherein said top portion of said frame further comprises a tool connection element for securing a tool to said top portion of said frame.

5) The device of claim 4, wherein said tool connection element extends outwardly from said top portion of said frame, wherein said tool connection element comprises at least one aperture for securing said tool.

6) The device of claim 5, wherein said tool connection element further comprises said at least one aperture for securing said hydraulic lift.

7) The device of claim 1, wherein a length of said frame is adjustable by adjusting a relative position of said top portion and said bottom portion of said frame.

8) The device of claim 7, further comprising a frame locking mechanism, wherein said frame locking mechanism is positioned to lock said top portion and said bottom portion in said relative position.

9) The device of claim 7, wherein said top portion and said bottom portion are slideably attached to one another.

10) The device of claim 9, wherein said top portion and said bottom portion are telescopic relative to one another such that said length of said frame is adjustable.

11) The device of claim 1, further comprising a lifting device attachment element connected to said top portion of said frame,
wherein said lifting device attachment element is opposite said at least one wheel and said lifting platform.

12) A transportation and elevation assist device comprising:
a frame having a top portion and a bottom portion,
a lifting device attachment element extending outwardly from said top portion,
at least one wheel connected to said bottom portion, and
at least one lifting platform connected to a base leg of said bottom portion.

13) The device of claim 12, further comprising a frame lift attachment connected to said bottom portion.

14) The device of claim 12, wherein said lifting device attachment element and said frame lift attachment comprise at least one aperture for securing a hydraulic lift.

15) The device of claim 14, wherein a housing of said hydraulic lift is secured to said frame via said at least one aperture of said lifting device attachment element, wherein a strut of said hydraulic lift is secured to said frame via said at least one aperture of said frame lift attachment, wherein said strut moves in a direction generally parallel to said top portion and said bottom portion of said frame.

16) The device of claim 14, further comprising a tool connection element, wherein said tool connection element is used to secure a tool.

17) The device of claim 16, wherein said tool connection element further comprises said at least one aperture for securing said hydraulic lift.

18) A method of liberating a bit from material comprising:
providing a tool having a bit stuck in a material,
providing a transportation and elevation assist device comprising a frame having a hydraulic lift connection element, a tool connection element, an at least one wheel, and a lifting platform,
providing a hydraulic lift,
attaching said hydraulic lift to said frame via said hydraulic lift connection element,
attaching said tool having said bit stuck in said material to said frame via said tool connection element, and
activating said hydraulic lift such that force is exerted on said lifting platform and said bit is loosed from said material.

19) The method of claim 18, wherein said frame comprises a top portion and bottom portion, wherein a length of said frame is adjustable by adjusting a relative position of said top portion and said bottom portion.

20) The method of claim 19, further comprising the steps of:
adjusting said length of said frame in a way such that said tool may be attached to said frame; and
locking said top portion and said bottom portion in said relative position.
